(19) United States
(12) Patent Application Publication
(10) Pub. No.: US 2024/0085444 A1
(43) Pub. Date: Mar. 14, 2024

(54) AUTOMATIC DISPENSING DEVICE

(71) Applicant: Shimadzu Corporation, Kyoto-shi (JP)

(72) Inventor: Koki MIYAZAKI, Kyoto-shi (JP)

(21) Appl. No.: 18/139,133

(22) Filed: Apr. 25, 2023

(30) Foreign Application Priority Data
Sep. 9, 2022 (JP) 2022-143865

(51) Int. Cl. G01N 35/10; G01N 35/00

(52) U.S. Cl. CPC G01N 35/1011; G01N 35/0099; G01N 35/1002; G01N 2035/1013

(57) ABSTRACT

An automatic dispensing device is provided with a sample container holder having a plurality of recesses, each of the recessed being configured to accommodate a sample container, a biasing member provided in each of the plurality of recesses, the biasing member being configured to bias the sample container accommodated in the recess upward, and a liquid dispensing mechanism having a discharge pipe for discharging a liquid from a tip end, the liquid dispensing mechanism being configured to discharge the liquid in a state in which the tip end of the discharge pipe is pressed against an inner part of the sample container at a predetermined dispensing target position from above.

### CROSS-REFERENCE TO RELATED APPLICATIONS

This application claims priority under 35 U.S.C. § 119 to Japanese Patent Application No. 2022-143865 filed on Sep. 9, 2022, the entire disclosure of which is incorporated herein by reference in its entirety.

### BACKGROUND OF THE INVENTION

### Field of the Invention

The present invention relates to an automatic dispensing device.

### Description of the Related Art

The following description sets forth the inventor's knowledge of related art and problems therein and should not be construed as an admission of knowledge in the prior art.

An analysis of a sample using an analytical instrument, such as, e.g., a liquid chromatograph, a gas chromatograph, or a mass analysis device, may sometimes require preprocessing prior to the analysis. The preprocessing includes, for example, extraction, purification, condensation, dilution, labeling, or staining of a detection target object contained in a sample. Conventionally, to efficiently perform such sample preprocessing, an automatic dispensing device configured to automatically dispense a liquid, such as, e.g., a liquid sample or a reagent, into a plurality of sample containers has been used.

Such an automatic dispensing device is provided with, for example, a dispensing pipette and a robot arm capable of gripping the dispensing pipette. The robot arm grips and moves the dispensing pipette and operates the dispensing pipette. With this, a predetermined amount of a liquid, such as, e.g., a reagent, is collected. Thereafter, the liquid is discharged into a predetermined sample container (see, e.g., Patent Document 1).

### PRIOR ART DOCUMENT

### Patent Document

Patent Document 1: Japanese Unexamined Patent Application Publication No. 2019-174369

### SUMMARY OF THE INVENTION

### Problems to be Solved by the Invention

In an automatic dispensing device described above, so-called contact dispensing may sometimes be performed to dispense a small amount of liquid stably. In so-called contact dispensing, in a state in which a tip end of a pipette tip attached to a dispensing pipette is in contact with an inner part of a sample container, such as, e.g., an inner bottom surface of a sample container, at a discharge target position a liquid is discharged. To properly perform such contact dispensing, a dispensing pipette is moved by the robot arm to a position directly above a sample container. Then, the dispensing pipette is lowered until the tip end of the pipette tip comes into contact with the inner part of the sample container at the discharge target potion, and then the liquid is discharged.

However, the distance from the tip end position of the pipette tip to the discharge target position at the time of starting the descent of the dispensing pipette varies depending on various factors. The various factors include variations in a fitting depth of a pipette tip to a dispensing pipette, a limit of positional reproducibility of a robot arm, variations in dimensions of a sample container or a container rack holding the sample container, and the like.

Therefore, even if the robot arm is controlled such that the dispensing pipette is lowered by a predetermined distance as a distance required for bringing the tip end of the pipette tip into contact with the inner part of the sample container at the discharge target position, there are the following disadvantages. That is, the pipette tip may not reach the discharge target position or may reach beyond the discharge target position. In such a case, appropriate contact dispensing cannot be performed.

The present invention has been made in view of the above-described circumstances. The purpose of the present invention is to provide an automatic dispensing device capable of stably performing appropriate contact dispensing.

### Means for Solving the Problem

An automatic dispensing device according to the present invention made to solve the above-described problems, includes:
a sample container holder having a plurality of recesses, each of the recessed being configured to accommodate a sample container;
a biasing member provided in each of the plurality of recesses, the biasing member being configured to bias the sample container accommodated in the recess upward; and
a liquid dispensing mechanism having a discharge pipe for discharging a liquid from a tip end, the liquid dispensing mechanism being configured to discharge the liquid in a state in which the tip end of the discharge pipe is pressed against an inner part of the sample container at a predetermined dispensing target position from above.

Further, an automatic dispensing device according to the present invention made to solve the above-described invention includes:
a sample plate holder configured to hold a sample plate in which a plurality of sample holding areas is formed;
a biasing member provided at a position corresponding directly below each of the plurality of sample holding areas of the sample plate holder, the biasing member being configured to bias the sample plate upward; and
   a liquid dispensing mechanism provided with a discharge pipe for discharging a liquid from a tip end, the liquid dispensing mechanism being configured to discharge the liquid in a state in which the tip end of the discharge pipe is pressed against a part of the sample plate corresponding to each of the plurality of sample holding areas from above.

### Effects of the Invention

According to the automatic dispensing device of the present invention having the above-described configuration, appropriate contact dispensing can be stably performed.

### BRIEF DESCRIPTION OF THE DRAWINGS

The preferred embodiments of the present invention are shown by way of example, and not limitation, in the accompanying figure.

FIG. 1 is a plan view showing a schematic configuration of a sample preprocessing device according to one embodiment of the present invention.

FIG. 2 is a vertical cross-sectional view showing a spin column and a collection tube used in a sample preprocessing device.

FIG. 3 is a vertical cross-sectional view showing a state in which a spin column and a collection tube are held in a temperature controller provided in a sample preprocessing device.

FIG. 4 is a vertical cross-sectional view showing a state in which contact dispensing is performed on a planar plate on a plate holder in a sample preprocessing device according to another embodiment of the present invention.

### DETAILED DESCRIPTION OF THE PREFERRED EMBODIMENTS

In the following paragraphs, some preferred embodiments of the present invention will be described by way of example and not limitation. It should be understood based on this disclosure that various other modifications can be made by those skilled in the art based on these illustrated embodiments.

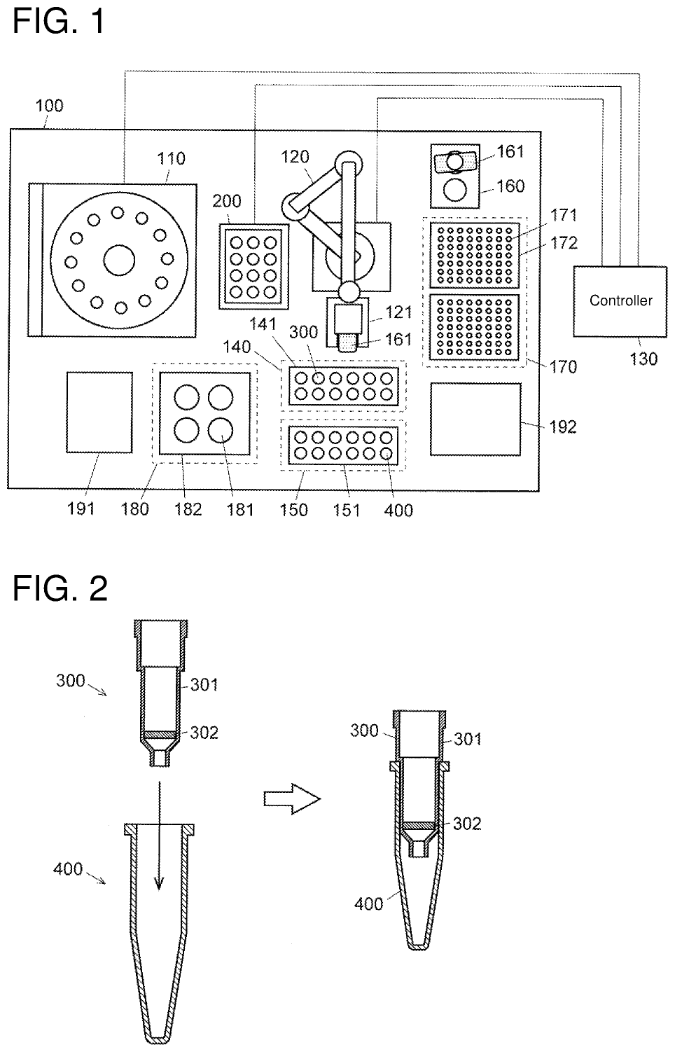

Hereinafter, a sample preprocessing device, which is one embodiment of an automatic dispensing device according to the present invention, will be described with reference to the attached figures. FIG. 1 is a top view showing a schematic configuration of a sample preprocessing device according to this embodiment. The sample preprocessing device is provided with a housing 100, a temperature controller 200 (corresponding to the “sample container holder” in the present invention) arranged in the housing 100, a centrifuge 110, a dispenser 161, a robot arm 120, and a controller 130.

Note that in this embodiment, the dispenser 161, the robot arm 120, and the controller 130 jointly function as a liquid dispensing mechanism according to the present invention. In the housing 100, a column rack arrangement portion 140, a tube rack arrangement portion 150, a dispenser housing 160, a chip rack arrangement portion 170, a reagent rack arrangement portion 180, a consumable disposal portion 191, and a preprocessed sample housing 192 are provided to surround the robot arm 120.

The column rack arrangement portion 140 is configured to place a column rack 141 accommodating a plurality of spin columns 300. The tube rack arrangement portion 150 is configured to place a tube rack 151 accommodating a plurality of collection tubes 400. The dispenser housing 160 is configured to accommodate one or a plurality of dispensers 161. The chip rack arrangement portion 170 is configured to place a tip rack 172 accommodating a plurality of pipette tips 171.

The reagent rack arrangement portion 180 is configured to place a reagent rack 182 accommodating one or more reagent containers 181. The consumable disposal portion 191 is configured to dispose of the used spin columns 300 and pipette tips 171. The preprocessed sample housing 192 is configured to accommodate a collection tube 400 containing a preprocessed sample.

As the dispenser 161 according to this embodiment, for example, a micropipette is used. A micropipette is generally provided with a cylinder, a plunger (or a piston), and a tubular nozzle connected to the lower end of the cylinder. The plunger is moved upward and downward in the cylinder with a disposable pipette tip (corresponding to the “discharge pipe” according to the present invention) attached to the lower end of the nozzle. Thus, a liquid can be sucked into the pipette tip, or a liquid can be discharged from the pipette tip.

Note that as the micropipette, an electric micropipette can be used. The electric micropipette is provided with, for example, a built-in motor for driving the plunger and an operating button for instructing to perform a suction operation and a discharge operation by driving the motor. Note that the micropipette is not limited to the above-described electric micropipette.

As the micropipette, a so-called manual micropipette may be used. The manual micropipette is provided with a push rod coupled to the upper end of the plunger and a spring for biasing the push rod upward. The plunger moves upward and downward by depressing a push button provided at an upper end of the push rod and releasing the depression of the button.

The robot arm 120 is provided with a hand portion 121. The hand portion 121 can grip the spin column 300, the collection tube 400, and the dispenser 161. Further, the hand portion 121 can operate the operation button or the push button provided on the dispenser 161.

The temperature controller 200, the centrifuge 110, and the robot arm 120 described above are controlled by the controller 130. The controller 130 is substantially a dedicated computer, or a general-purpose computer, such as, e.g., a personal computer. The functions of the controller 130 in this embodiment are realized by executing predetermined programs installed on the computer.

In FIG. 1, the controller 130 is arranged outside the housing 100, but the controller 130 may be arranged within the housing. Note that the controller 130 is connected to an input unit configured by a keyboard, an operating button, or the like, and a display unit configured by a liquid crystal display or the like. Note that these members are not illustrated for simplicity.

The column rack 141 holds a number of spin columns 300 as shown in FIG. 2. The tube rack 151 holds a number of collection tubes 400 as shown in FIG. 2.

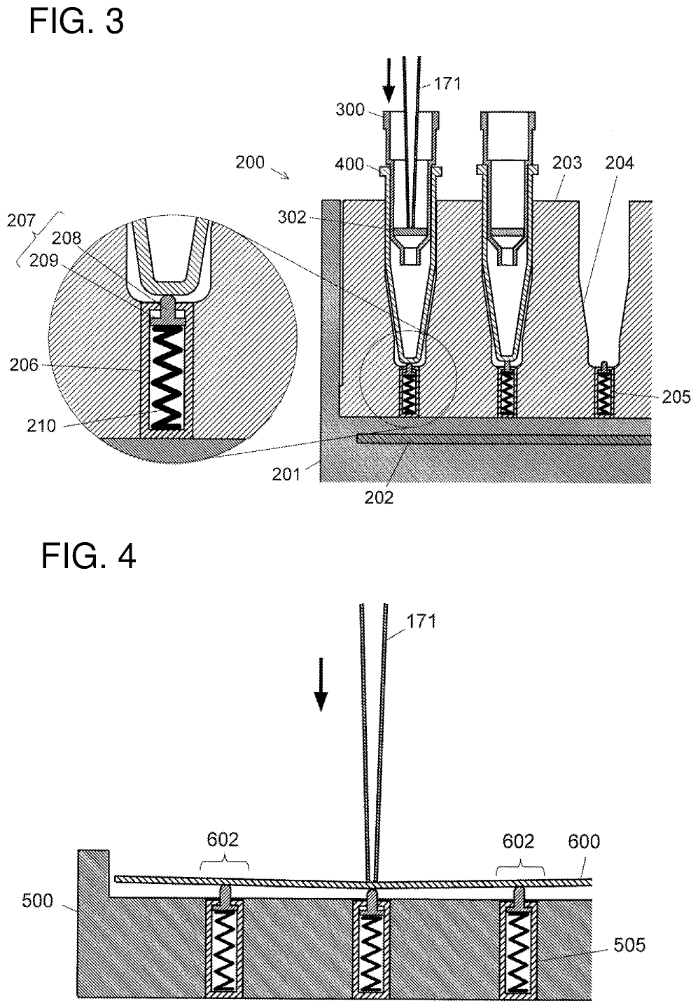

As the collection tube 400, a so-called microtube can be used (in FIG. 2 and FIG. 3, a lid is not illustrated for simplicity). The microtube is provided with a main body and a lid. The main body is a cylindrical or generally conical member having a diameter decreasing as it advances downward with a closed bottom and an open top. The lid is a member coupled to a peripheral edge of an upper end portion of the main body via a hinge and capable of closing an upper opening of the main body.

However, the collection tube 400 in this embodiment is not limited to such a microtube. The collection tube 400 may be any tube as long as it is capable of accommodating a liquid and attaching a spin column 300 described later.

On the other hand, the spin column 300 is provided with a cylindrical portion 301 having a circular upper opening and a circular lower opening having a smaller diameter than the upper opening, and a filter 302 held inside the cylindrical portion 301. The spin column 300 is insertable into the upper portion of the collection tube 400 as shown on the right side of FIG. 2. The filter 302 may be any filter as long as it can be used for solid phase extraction. For example, the filter 302 may be a filter made of a silica monolith, a silica membrane, a cellulose membrane, or a resinous carrier, such as, e.g., an ion-exchange resin.

The spin column 300 and the collection tube 400 in a state in which the spin column 300 is attached to the collection tube 400 as described above corresponds to the “sample container” according to the present invention. Further, in the above-described state, the region of the inner space of the cylindrical portion 301 of the spin column 300 above the filter 302 corresponds to the “upper space” in the present invention. In the above-described state, the region of the inner space of the collection tube 400 below the region where the spin column 300 is mounted corresponds to the “lower space” in the present invention.

The temperature controller 200 is provided with a base portion 201 and a heat transfer block 203 mounted on the base portion 201. The base portion 201 has, on its upper portion, a recess for accommodating the heat transfer block 203. Below the inner bottom surface of the recess, there is provided with a heater 202 for heating the heat transfer block 203 and a temperature sensor (not shown) for measuring the temperature of the heat transfer block 203.

Note that the temperature controller 200 may be provided with a cooling function using, for example, a fan or a Peltier device, in addition to the above-described heating function using the heater 202. The heat transfer block 203 is made of a highly thermally conductive material, such as, e.g., aluminum. On the upper surface of the heat transfer block 203, a tube accommodating portion 204 (corresponding to the “recess” according to the present invention) which is a recess for accommodating the collection tube 400 is provided. A cylindrical cavity is provided below each tube accommodating portion 204. A spring plunger 205 (corresponding to the “biasing member” according to the present invention) is fitted in the cavity.

The cavity may be a through-hole having an upper end open to the inner bottom surface of the tube accommodating portion 204 and a lower end open to the lower surface of the heat transfer block 203. Alternatively, the cavity may have a concave shape in which only the upper end is opened.

The spring plunger 205 is provided with a hollow-cylindrical holder 206, a compression coil spring 210 housed in the holder 206, and a pin member 207 with a portion retractable from the holder 206. The pin member 207 is composed of a protrusion 208 that protrudes to the outside of the holder 206 from a through-hole (not shown) provided in the upper surface of the holder 206, and a flange-shaped retaining portion 209 provided at the base end of the protrusion 208 in a vertically slidable manner in the holder 206. The lower surface of the retaining portion 209 is in contact with the upper end of the compression coil spring 210, and the pin member 207 is constantly biased upward by the biasing force of the compression coil spring 210.

Instead of the spring plunger 205 equipped with the above-described pin member 207, a so-called ball plunger equipped with a ball in which a part thereof is retractable from the holder 206 and a spring for biasing the ball may be used.

Hereinafter, a flow of the preprocessing by the preprocessing device according to this embodiment will be described. At the time of starting the preprocessing, in the column rack 141 and the tube rack 151, a plurality of spin columns 300 and a plurality of collection tubes 400 are held, respectively. At this time, a predetermined quantity of a liquid sample has been added to each spin column 300 in advance, and target components in the sample have been adsorbed in the filter 302.

First, under the control of the controller 130, the robot arm 120 grasps the collection tube 400 held by the tube rack 151 and places it at the tube accommodating portion 204 of the temperature controller 200. Subsequently, the robot arm 120 grips the spin column 300 held by the column rack 141 and puts it to the collection tube 400 on the temperature controller 200.

At this time, in the tube accommodating portion 204, the bottom of the collection tube 400 is in contact with the tip end of the pin member 207 of the spring plunger 205. However, the spin column 300 and the collection tube 400 are relatively light in weight, and therefore, depression of the pin member 207 due to the contact by the collection tube 400 hardly occurs.

Next, the robot arm 120 grips a dispenser 161 accommodated in the dispenser housing 160 and moves the dispenser 161 to a position above the chip rack arrangement portion 170. The robot arm 120 lowers the dispenser 161 toward any one of the pipette tips 171 accommodated in the tip rack 172 and attaches the pipette tip 171 to the nozzle tip of the dispenser 161.

Next, the robot arm 120 moves the dispenser 161 to insert the tip of the pipette tip 171 into any one of the reagent containers 181 on the reagent rack 182. Then, a predetermined quantity of the reagent is collected by operating the operating button or the like provided on the dispenser 161.

Thereafter, the robot arm 120 moves the dispenser 161 to a position directly above the collection tube 400 and the spin column 300 accommodated in any one of the tube accommodating portions 204 on the temperature controller 200. Then, the dispenser 161 is lowered by a predetermined distance from the position (hereinafter referred to as the “initial position”), and the tip end of the pipette tip 171 is brought into contact with the center of the upper surface of the filter 302 (corresponding to the “dispensing target position” according to the present invention) in the spin column 300 (see FIG. 3). Then, in this state, the robot arm 120 operates the operating button or the like provided on the dispenser 161 to discharge the reagent from the pipette tip 171.

Note that the distance from the height of the initial position to the upper surface of the filter 302 (hereinafter referred to as the “distance between the initial position and the filter”) varies depending on various factors. Various factors include, for example, variations in the fitting depth of the pipette tip 171 to the nozzle of the dispenser 161, the limit of positional reproducibility of the robot arm 120, variations in dimensions of the collection tube 400, the spin column 300, and the tube accommodating portion 204.

Therefore, to absorb the variations in the distance between the initial position and the filter, the spring plunger 205 is set so that the stroke of the pin member 207 is equal to or larger than the difference between the maximum value and the minimum value of the distance between the initial position and the filter when the variations due to the above-described factors are considered. Further, the descent distance from the initial position is set to be larger by a predetermined distance than the distance between the initial position and the filter when it is assumed that there is no distance variation as described above (the predetermined distance corresponds to the “displacement amount” according to the present invention).

With this, regardless of the variations in the distance between the initial position and the filter as described above, the reagent can be discharged in a state in which the tip end of the pipette tip 171 is always in contact with the upper portion of the filter 302, which enables stable dispensing even in a case where the dispensing amount of the reagent is small. Further, when the tip end of the pipette tip 171 presses against the upper surface of the filter 302 in accordance with the lowering of the dispenser 161, the compression coil spring 210 of the spring plunger 205 is compressed by the pressing force. Accordingly, the collection tube 400 and the spin column 300 are slightly lowered. Therefore, it is possible to prevent the pipette tip 171 from being strongly pressed against the upper surface of the filter 302, thereby preventing the filter 302 from being damaged.

As the compression coil spring 210, for example, a spring having a spring constant of 0.10 N/mm to 1.02 N/mm, preferably 0.2 N/mm to 0.5 N/mm can be used. Further, the controller 130 controls the robot arm 120 such that, for example, the displacement of the collection tube 400 and the spin column 300 caused by the pressing of the pipette tip 171 becomes 0.5 mm to 5.0 mm, preferably 0.25 mm to 1 mm.

However, an appropriate value of the spring constant and that of the displacement amount in this embodiment vary depending on the type (hardness, material, or dry state) of the filter 302, the type (hardness, material, or tip shape) of the pipette tip 171, and the like. Therefore, it is desirable to determine the appropriate spring constant and displacement by trials using the filter 302 and the pipette tip 171 to be actually used, and to use a compression coil spring 210 of the appropriate spring constant. The appropriate spring constant and displacement are such that the tip end of the pipette tip 171 assuredly comes into contact with the filter 302 but does not damage the filter 302. In addition, it is desirable to adjust the control amount of the robot arm 120 by the controller 130 so that the displacement amount becomes an appropriate value.

After dispensing the reagent according to the above-described procedures for each of the spin columns 300 accommodated in all the collection tubes 400 on the temperature controller 200, the collection tubes 400 and the spin columns 300 are incubated for a predetermined time on the temperature controller 200. Thereafter, each collection tube 400 and each spin column 300 attached to the collection tube 400 are transferred by the robot arm 120 to the centrifuge 110 and centrifuged to collect the desired components in the sample in each collection tube 400.

Thereafter, the robot arm 120 removes each spin column 300 from each collection tube 400 and disposes the spin column into the consumable disposal portion 191, and closes the cover of the collection tube 400 and transfers it to the preprocessed sample housing 192.

Here, in order to simplify the explanation, only one type of reagent is dispensed to each spin column 300, but dispensing of a plurality of types of reagents may be performed to each spin column 300.

Although an embodiment for carrying out the invention has been described with reference to a specific embodiment, the present invention is not limited to the above-described configuration and can be modified as appropriate.

For example, the biasing member according to the present invention is not limited to a member using a compression coil spring, such as, e.g., a spring plunger described above. The biasing member may be a member that biases a sample container upward by another elastic body, such as, e.g., a leaf spring and a block made of an elastomer. Alternatively, the biasing member may be a member that biases a sample container upward by repulsive force of a magnet.

Further, the sample dispensing device according to the present invention may be a preprocessing device such as the embodiment described above, or may be a device that performs only dispensing without performing preprocessing.

In the above-described embodiment, it is configured to provide a biasing member according to the present invention on the temperature controller 200, but the present invention is not limited thereto. For example, a tube rack with no temperature control function may be provided with a biasing member according to the present invention, and the above-described contact dispensing is performed in a state in which the sample containers are held by the tube rack. In this case, the tube rack corresponds to the “sample container holder” according to the present invention.

Further, in the above-described embodiment, dispensing of the reagent is performed by bringing the tip end of the pipette tip 171 into contact with the filter 302 provided in the spin column 300, but the present invention is not limited thereto. For example, dispensing of the reagent may be performed by bringing the tip end of the pipette tip into contact with the inner bottom surface of the microtube not equipped with the spin column 300. Alternatively, dispensing of the reagent may be performed by bringing the tip end of the pipette tip 171 into contact with the bottom surface (corresponding to the “sample holding area” in the present invention) of each of the plurality of wells provided in the microtiter plate, or each of the plurality of sample holding areas formed in the plate-like plate.

In such cases, a biasing member composed of the above-described spring plunger or the like is provided. This biasing member is provided on a lower surface of the plurality of wells or a position where the lower surface of the position comes into contact with a temperature controller or a holder (plate holder) that does not have a temperature control function on which a microtiter plate or a plate-like plate is placed.

In this case, the microtiter plate or the plate-like plate corresponds to the “sample plate” according to the present invention. The temperature controller on which the microtiter plate or the plate-like plate is placed or a holder that does not have the temperature control function corresponds to the “sample plate holder” according to the present invention.

An exemplary configuration for such cases is shown in FIG. 4. This figure shows an automatic dispensing device configured to perform contact dispensing by bringing the tip of the pipette tip 171 into contact with each of a plurality of sample holding areas 602 formed on the upper surface of the planar plate 600. Here, the planar plate 600 is placed on the plate holder 500, and a spring plunger 505 is arranged in the plate holder 500 at a position corresponding to a position immediately below each sample holding area 602.

The dispenser 161 is not limited to a single-channel micropipette and may be a multi-channel micropipette. Further, in the above-described embodiment, dispensing the reagent was performed by moving and operating the dispenser 161 by the robot arm 120. However, the present invention is not limited thereto. For example, it may be configured as follows. A pipe having one end to be inserted into a reagent container and the other end to which a nozzle (corresponding to the “discharge pipe” according to the present invention) for discharging a liquid, and a pump for sucking a reagent from the one end of the pipe and discharging the reagent from the other end of the pipe are provided. Further, a moving mechanism for moving the nozzle up and down, back and forth, and left and right is provided. Then, discharging the reagent is performed in a state in which the tip end of the nozzle is in contact with a discharge target position in the sample container.

### ASPECTS

It is apparent to those skilled in the art that the above-described exemplary embodiments are specific examples of the following aspects.

### (Item 1)

An automatic dispensing device according to the present invention includes:
a sample container holder having a plurality of recesses, each of the recessed being configured to accommodate a sample container;
a biasing member provided in each of the plurality of recesses, the biasing member being configured to bias the sample container accommodated in the recess upward; and
a liquid dispensing mechanism having a discharge pipe for discharging a liquid from a tip end, the liquid dispensing mechanism being configured to discharge the liquid in a state in which the tip end of the discharge pipe is pressed against an inner part of the sample container at a predetermined dispensing target position from above.

According to the automatic dispensing device as recited in the above-described Item 1, the variation in the distance from the tip end of the discharge pipe to the dispensing target position at the reference position can be absorbed by the biasing member, and therefore, stable contact dispensing can always be performed.

### (Item 2)

According to the automatic dispensing device as recited in the above-described Item 2, in the automatic dispensing device as recited in the above-described Item 1,
the liquid dispensing mechanism is configured to discharge the liquid after lowering the tip end of the discharge pipe by a predetermined distance from a predetermined initial position above the sample container

### (Item 3)

According to the automatic dispensing device as recited in the above-described Item 3, in the automatic dispensing device as recited in the above-described Item 1 or 2,
the biasing member is configured to come into contact with the sample container from below.

### (Item 4)

According to the automatic dispensing device as recited in the above-described Item 4, in the automatic dispensing device as recited in any one of the above-described Items 1 to 3,
the sample container holder is configured to hold a container as the sample container including a filter, the sample container having an upper space and a lower space partitioned by the filter, and
the dispensing target position is a position on an upper surface of the filter equipped by the sample container accommodated in each of the plurality of recesses.

According to the automatic dispensing device as recited in the above-described Item 4, it is possible to prevent the tip end of the discharge pipe from being strongly pressed against the upper surface of the filter, which can prevent the filter from being damaged by the pressing of the discharge pipe.

### (Item 5)

According to the automatic dispensing device as recited in the above-described Item 5, in the automatic dispensing device as recited in any one of the above-described Items 1 to 4,
the sample container holder is a temperature controller provided with a heat transfer block and a heater for heating the heat transfer block, and
the plurality of recesses is provided on an upper surface of the heat transfer block.

According to the automatic dispensing device as recited in the above-described Item 5, stable contacting dispensing can be performed on the sample container held on the temperature controller.

### (Item 6)

According to the automatic dispensing device as recited in the above-described Item 6, includes:
a sample plate holder configured to hold the sample plate in which a plurality of sample holding areas is formed;
a biasing member provided at a position corresponding directly below each of the plurality of sample holding areas of the sample plate holder, the biasing member being configured to bias the sample plate upward; and
a liquid dispensing mechanism provided with a discharge pipe for discharging a liquid from a tip end, the liquid dispensing mechanism being configured to discharge the liquid in a state in which the tip end of the discharge pipe is pressed against a part of the sample plate corresponding to each of the plurality of sample holding areas from above.

According to the automatic dispensing device as recited in the above-described Item 6, since the biasing member can absorb the variation in the height from the tip end of the discharge pipe to the sample holding area at the reference position, stable contact dispensing can be performed constantly.

### DESCRIPTION OF SYMBOLS

100: Housing
110: Centrifuge
120: Robot arm
130: Controller
161: Dispenser
171: Pipette tip
181: Reagent container
200: Temperature controller
201: Base portion
202: Heater
203: Heat transfer block
204: Tube accommodating portion
205: Spring plunger
206: Holder
207: Pin member
300: Spin column
302: Filter
400: Collection tube

1. An automatic dispensing device comprising:
a sample container holder having a plurality of recesses, each of the recesses being configured to accommodate a sample container;
a biasing member provided in each of the plurality of recesses, the biasing member being configured to bias the sample container accommodated in the recess upward; and
a liquid dispensing mechanism having a discharge pipe for discharging a liquid from a tip end, the liquid dispensing mechanism being configured to discharge the liquid in a state in which the tip end of the discharge pipe is pressed against an inner part of the sample container at a predetermined dispensing target position from above.

2. The automatic dispensing device as recited in claim 1,
wherein the liquid dispensing mechanism is configured to discharge the liquid after lowering the tip end of the discharge pipe by a predetermined distance from a predetermined initial position above the sample container.

3. The automatic dispensing device as recited in claim 1,
wherein the biasing member is configured to come into contact with the sample container from below.

4. The automatic dispensing device as recited in claim 1,
wherein the sample container holder is configured to hold a container as the sample container including a filter, the sample container having an upper space and a lower space partitioned by the filter, and
wherein the dispensing target position is a position on an upper surface of the filter equipped by the sample container accommodated in each of the plurality of recesses.

5. The automatic dispensing device as recited in claim 1,
wherein the sample container holder is a temperature controller provided with a heat transfer block and a heater for heating the heat transfer block, and
wherein the plurality of recesses is provided on an upper surface of the heat transfer block.

6. An automatic dispensing device comprising:
a sample plate holder configured to hold a sample plate in which a plurality of sample holding areas is formed;
a biasing member provided at a position corresponding directly below each of the plurality of sample holding areas of the sample plate holder, the biasing member being configured to bias the sample plate upward; and
a liquid dispensing mechanism provided with a discharge pipe for discharging a liquid from a tip end, the liquid dispensing mechanism being configured to discharge the liquid in a state in which the tip end of the discharge pipe is pressed against a part of the sample plate corresponding to each of the plurality of sample holding areas from above.
